(19) United States
(12) Patent Application Publication
(10) Pub. No.: US 2015/0192099 A1
(43) Pub. Date: Jul. 9, 2015

(54) SPARK PLUG AND INTERNAL COMBUSTION ENGINE PROVIDED THEREWITH

(71) Applicants: Akihiro Ando, Okazaki-shi (JP); Motomasa Iizuka, Anjo-shi (JP); Koichi Nakata, Mishima-shi (JP); Shinichiro Nogawa, Mishima-shi (JP); Kotaro Suzuki, Minamiashigara-shi (JP)

(72) Inventors: Akihiro Ando, Okazaki-shi (JP); Motomasa Iizuka, Anjo-shi (JP); Koichi Nakata, Mishima-shi (JP); Shinichiro Nogawa, Mishima-shi (JP); Kotaro Suzuki, Minamiashigara-shi (JP)

(21) Appl. No.: 14/412,281

(22) PCT Filed: Jul. 1, 2013
(86) PCT No.: PCT/IB2013/001395

§ 371 Date: Dec. 31, 2014

(30) Foreign Application Priority Data
Jul. 3, 2012 (JP) 2012-149930

(51) Int. Cl. F02P 15/00; H01T 13/20

(52) U.S. Cl. CPC F02P 15/006; H01T 13/20

(57) ABSTRACT

A spark plug includes a housing portion; an insulator that is retained in the housing portion; a center electrode that is exposed from the insulator; and a ground electrode that forms a discharge gap between the ground electrode and the center electrode. A plug pocket is formed between the housing portion and the insulator. In the spark plug, a tapered portion is provided on an inside of one of two portions of a tip end portion of the housing portion that face each other in a radial direction of the housing portion, and the ground electrode is provided on the other portion.

### BACKGROUND OF THE INVENTION

1. Field of the Invention

The invention relates to a spark plug and an internal combustion engine provided with this spark plug.

2. Description of Related Art

Pre-ignition sometimes occurs in an internal combustion engine provided with a spark plug. Regarding this, Japanese Patent Application Publication No. 2000-133411 (JP 2000-133411 A) describes a spark plug with an integrated coil in which the main fixture is made of a copper alloy or an aluminum alloy. In JP 2000-133411 A, a heat resistant spark plug with an integrated coil in which pre-ignition will not occur is able to be realized by improving heat transfer such that an external electrode and the main fixture will not become high in temperature. Technology considered to be related to the invention is also described in Japanese Patent Application Publication No. 2008-108478 (JP 2008-108478 A), Japanese Patent Application Publication No. 2010-267625 (JP 2010-267625 A), and International Publication No. WO 2008/102842, for example.

It is now known that pre-ignition occurs due to air-fuel mixture that remains in a plug pocket formed between a housing and an insulator being subjected to heat and becoming high in temperature. In order to inhibit the occurrence of pre-ignition caused by air-fuel mixture remaining in the plug pocket, it is necessary to improve the temperature state of the plug pocket. Therefore, it is not possible to inhibit the occurrence of pre-ignition that is caused by air-fuel mixture that remains in the plug pocket, by preventing the external electrode and the main fixture from becoming high in temperature like the spark plug with an integrated coil described in JP 2000-133411 A does, for example.

### SUMMARY OF THE INVENTION

In view of the forgoing problem, the invention provides a spark plug capable of inhibiting the occurrence of pre-ignition caused by air-fuel mixture that remains in a plug pocket.

One aspect of the invention relates to a spark plug that includes a housing portion; an insulator that is retained in the housing portion; a center electrode that is exposed from the insulator; and a ground electrode that forms a discharge gap between the ground electrode and the center electrode. A plug pocket is formed between the housing portion and the insulator. A tapered portion is provided on an inside of one of two portions of a tip end portion of the housing portion that face each other in a radial direction of the housing portion, and the ground electrode is provided on the other portion.

In the spark plug according to this aspect of the invention, a width of a space formed by portions of end portions of the tapered portion in a circumferential direction, which are adjacent to the plug pocket, may be of a size that is equal to or greater than an outer diameter of the insulator at a predetermined position in an axial direction of the spark plug.

In the spark plug according to this aspect of the invention, a length, in a circumferential direction, of an outer peripheral portion of the tapered portion, which is positioned on a radially outer side of the tapered portion, may be longer than a length, in the circumferential direction, of an inner peripheral portion of the tapered portion, which is positioned on a radially inner side of the tapered portion.

Accordingly, the invention makes it possible to inhibit the occurrence of pre-ignition caused by air-fuel mixture that remains in a plug pocket.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1A is a view of the main portions of a spark plug according to a first example embodiment of the invention;

FIG. 1B is a bottom view of the spark plug as viewed in the axial direction from a ground electrode side;

FIG. 2A is a view of one possible arrangement area of a tapered portion of the first example embodiment, and shows the tapered portion provided as small as possible along a circumferential direction;

FIG. 2B is a view of another possible arrangement area of the tapered portion of the first example embodiment, and shows the tapered portion provided as large as possible along the circumferential direction;

FIG. 3A is a view showing the manner in which airflow flows into a plug pocket;

FIG. 3B is a view showing the manner in which airflow flows into a plug pocket;

FIG. 4 is a view of one example of self-ignition incidence;

FIG. 5 is a view of one example of a surface temperature of an insulator;

FIG. 6A is a view of another arrangement example of the ground electrode;

FIG. 6B is a bottom view of the spark plug in FIG. 6A;

FIG. 7A is a view of the main portions of a spark plug according to a second example embodiment of the invention;

FIG. 7B is a bottom view of the spark plug in FIG. 7A;

FIG. 8A is a view of one possible arrangement area of a tapered portion of the second example embodiment, and shows the tapered portion provided as small as possible along a circumferential direction; and

FIG. 8B is a view of another possible arrangement area of the tapered portion of the second example embodiment, and shows the tapered portion provided as large as possible along the circumferential direction.

### DETAILED DESCRIPTION OF EMBODIMENTS

Hereinafter, example embodiments of the invention will be described with reference to the accompanying drawings.

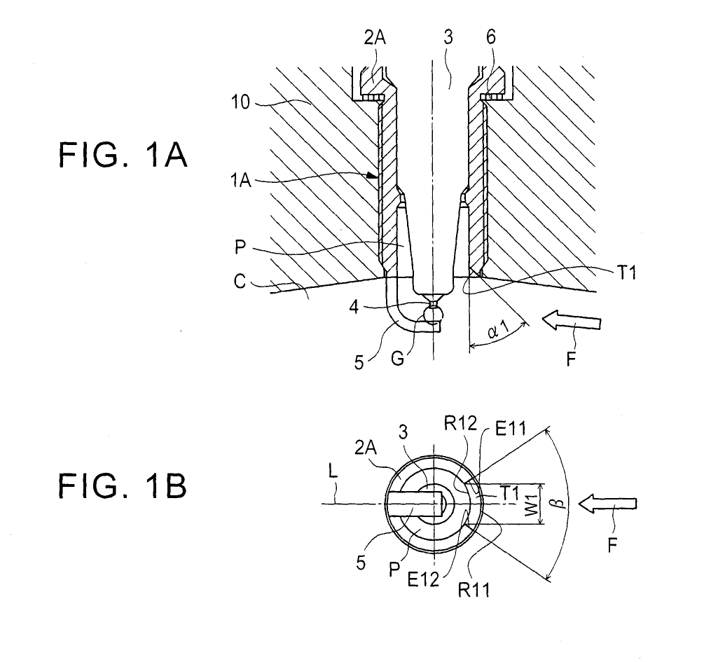

FIGS. 1A and 1B are views of the main portions of a spark plug 1A. FIG. 1A is a sectional view of the spark plug 1A. FIG. 1B is a bottom view of the spark plug 1A (i.e., a view in the axial direction from the side with a ground electrode 5). FIGS. 1A and 1B show the main portions of the spark plug 1A in a state provided in a cylinder head 10 of an internal combustion engine.

The spark plug 1A includes a housing portion 2A, an insulator 3, a center electrode 4, and a ground electrode 5. The housing portion 2A has a cylindrical shape and retains the insulator 3. The insulator 3 is provided surrounding the center electrode 4. The center electrode 4 extends along the axial direction. Also, the center electrode 4 is exposed from the insulator 3 at a tip end side (i.e., the side on which the ground electrode 5 is provided in the axial direction, when the spark plug 1A is viewed in a direction orthogonal to a central axis thereof). The ground electrode 5 is provided on the housing portion 2A. A discharge gap G is formed between this ground electrode 5 and the center electrode 4.

The spark plug 1A is provided in the cylinder head 10. More specifically, the spark plug 1A is fastened to the cylinder head 10 via a gasket 6. The cylinder head 10, together with a cylinder block and a piston, neither of which are shown, forms a combustion chamber C. The discharge gap G is arranged in the combustion chamber C. An airflow F that flows through the discharge gap G is created in the combustion chamber C. More specifically, the airflow F is a tumble flow. This airflow F is able to be made into an airflow that flows through the discharge gap G during at least one of an intake stroke and a compression stroke of the internal combustion engine provided with the spark plug 1A. The airflow F is not necessarily limited to the tumble flow. That is, the airflow F may also be a swirl flow, for example. In the internal combustion engine provided with the spark plug 1A, the spark plug 1A is provided such that the housing portion 2A does not protrude into the combustion chamber C.

A plug pocket P is formed between the housing portion 2A and the insulator 3. This plug pocket P is formed around the insulator 3 and is open to the combustion chamber C. A tapered portion T1 is provided on the housing portion 2A. The tapered portion T1 is provided on an inside of one of two portions that face each other in the radial direction, of a tip end portion that is an end portion on a tip end side of the housing portion 2A. Also, the other portion is a portion on which the ground electrode 5 is provided. The tapered portion T1 is provided only on the one portion, of the tip end portion of the housing portion 2A. The tapered portion T1 is provided so as to include a center line L when viewed in the axial direction from the tip end side. This center line L is a center line of the ground electrode 5 when viewed in the axial direction from the tip end side, and extends along in the extending direction of the ground electrode 5.

The tapered portion T1 has end portions E11 and E12 in a circumferential direction. The end portions E11 and E12 form a width W1. This width W1 is a width of a space formed by portions of the end portions E11 and E12, which are adjacent to the plug pocket P. More specifically, the width W1 is formed in a direction orthogonal to the center line L when viewed in the axial direction from the tip end side. Also, the tapered portion T1 is formed such that a center line thereof overlaps with the center line L when viewed in the axial direction from the tip end side. Therefore, the tapered portion T1 has a shape that is symmetrical and sandwiches the center line L when viewed in the axial direction from the tip end side.

The width W1 is set to a size equal to or greater than an outer diameter of the insulator 3 at a predetermined position in the axial direction. The predetermined position may be a position that is included in the area where the plug pocket P is formed, in the axial direction. Further, the predetermined area may be a position that is included in an area that expands from the position where the width W1 is formed in the axial direction to a rear end side (i.e., the side opposite the side where the ground electrode 5 is provided in the axial direction, when the spark plug 1A is viewed in a direction orthogonal to the central axis thereof). More specifically, the predetermined position may be a position where the width W1 is formed in the axial direction, for example. The width W1 is the smallest width, among the widths where the end portions E11 and E12 are formed in the positions in the axial direction.

The tapered portion T1 includes an outer peripheral portion R11 positioned on the radially outer side, and an inner peripheral portion R12 positioned on the radially inner side. The tapered portion T1 is provided such that a length of the outer peripheral portion R11 in the circumferential direction is longer than the length of the inner peripheral portion R12 in the circumferential direction. More specifically, the tapered portion T1 is provided having a shape that fans outward, with the width of the space formed by the end portions E11 and E12 gradually increasing from the inside toward the outside when viewed in the axial direction from the tip end side. Regarding this point, the end portions E11 and E12 each extend in the radial direction when viewed in the axial direction from the tip end side.

The tapered portion T1 has a taper angle α1 and a notch angle β. The taper angle α1 is an acute angle formed by a central axis of the spark plug 1A and a tapered surface of the tapered portion T1, in a cross-section of the tapered portion T1 that includes the central axis of the spark plug 1A. The notch angle β is an angle between the end portions E11 and E12 when viewed in the axial direction from the tip end side. The taper angle α1 is set at 45°, and the notch angle β is set at 60°. The taper angle α1 and the notch angle β may both be set equal to or greater than 30°.

The tapered portion T1 may be provided so as to form a portion of a tip end outer peripheral portion of the housing portion 2A. The tapered portion T1 may also be provided such that the outer peripheral portion R11 is positioned farther toward the rear end side than a tip end surface of the housing portion 2A, in the axial direction. Also, the tapered portion T1 may also be provided such that the tip end surface of the housing portion 2A stays within the area of the notch angle β (i.e., may be provided to the inside of the tip end outer peripheral portion of the housing portion 2A) when viewed in the axial direction from the tip end side.

More specifically, when providing the tapered portion T1 on the one portion described above, the tapered portion T1 may be provided in the following manner.

That is, the tapered portion T1 may be provided on a portion of the tip end portion of the housing portion 2A that includes the central axis of the spark plug 1A when viewed in the axial direction from the tip end side, and that is on the opposite side of a plane that is orthogonal to the center line L from the side on which the ground electrode 5 is provided. In other words, more specifically, the one portion may be the portion on the opposite side.

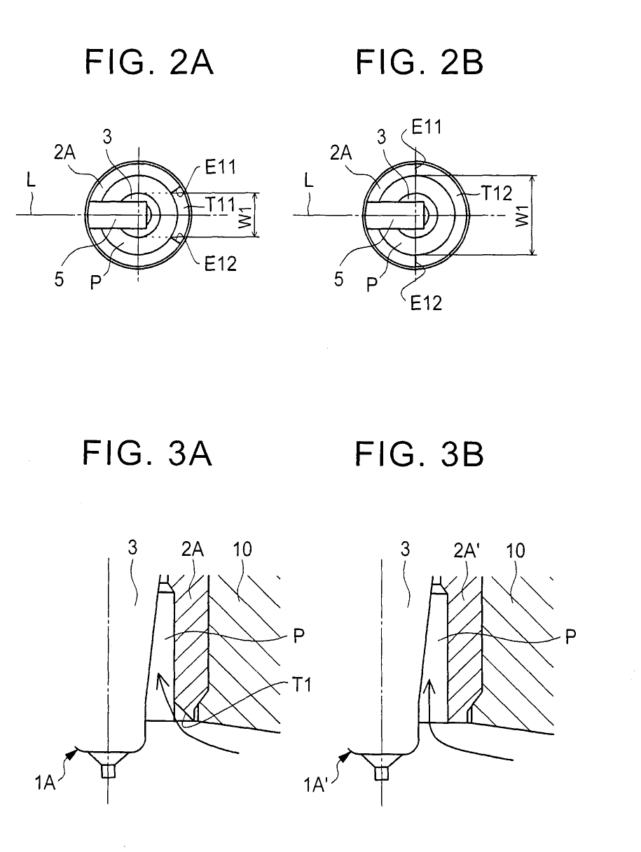

FIGS. 2A and 2B are views of possible arrangement areas of a tapered portion T1 in the circumferential direction. FIG. 2A is a view showing a tapered portion T11 that serves as the tapered portion T1 provided as small as possible along the circumferential direction. FIG. 2B is a view showing a tapered portion T12 that serves as the tapered portion T1 provided as large as possible along the circumferential direction. With the tapered portion T11, the width W1 is set to match the size of the outer diameter of the insulator 3 at the position where the width W1 is formed in the axial direction, as shown in FIG. 2A. With the tapered portion T12, the width W1 is set to match the diameter of the portion of the housing portion 2A that is adjacent to the plug pocket P, as shown in FIG. 2B. With the tapered portion T12, the end portions E11 and E12 are provided to include the central axis of the spark plug 1A, and so as to be included in a plane that is orthogonal to the center line L.

Next, the main operation and effects of the spark plug 1A will be described. Here, when providing the spark plug 1A in the cylinder head 10, the position of the ground electrode 5 in the circumferential direction is typically not set to a predetermined position. Therefore, the ground electrode 5 may sometimes be arranged such that a discharge end portion thereof faces the airflow F when viewed in the axial direction from the tip end side, as shown in FIG. 1B, when the spark plug 1A is provided in the cylinder head 10. However, when the ground electrode 5 is arranged this way, pre-ignition tends to occur from the air-fuel mixture that remains in the plug pocket P, as will be described next.

That is, in this case, the airflow that tries to flow out of the plug pocket P, of the airflow that tries to flow into the plug pocket P and the airflow that tries to flow out of the plug pocket P, is impeded from flowing out by the ground electrode 5. Also, because the outflow of this airflow from the plug pocket P is impeded, airflow also has difficulty flowing into the plug pocket P. As a result, air-fuel mixture tends to remain in the plug pocket P, so pre-ignition tends to occur from the air-fuel mixture that remains in the plug pocket P.

In contrast, with the spark plug 1A, the tapered portion T1 is provided on the inside of one of two portions of the tip end portion of the housing portion 2A that face each other in the radial direction, and the ground electrode 5 is provided on the other portion. Therefore, the spark plug 1A is able to change the direction of the airflow that flows into the plug pocket P, as will be described next.

FIGS. 3A and 3B are views showing the manner in which airflow flows into the plug pocket P. FIG. 3A is a view of a case with the spark plug 1A, and FIG. 3B is a view of a case with a spark plug 1A′. The spark plug 1A′ is substantially the same as the spark plug 1A except that it is provided with a housing portion 2A′ instead of the housing portion 2A. The housing portion 2A′ is substantially the same as the housing portion 2A except that the tapered portion T1 is not provided. As shown in FIGS. 3A and 3B, even if the ground electrode 5 is arranged as described above, the spark plug 1A is able to gradually change the direction of the airflow that flows into the plug pocket P compared to the spark plug 1A′, by providing the tapered portion T1.

Therefore, with the spark plug 1A, the airflow is able to more easily flow into the plug pocket P, and the flow rate of the airflow in the plug pocket P is able to be increased, by reducing the inflow resistance of the airflow. As a result, the temperature state of the plug pocket P is able to be improved by increasing the scavenging ability of the plug pocket P. Therefore, the occurrence of pre-ignition caused by air-fuel mixture remaining in the plug pocket P is able to be inhibited.

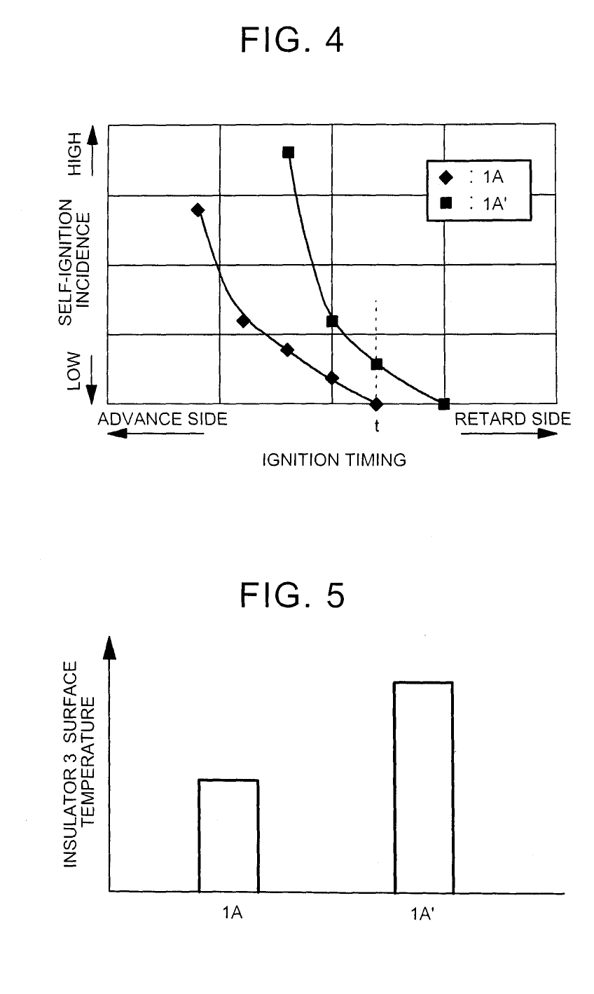

FIG. 4 is a view of one example of self-ignition incidence, and FIG. 5 is a view of one example of a surface temperature of the insulator 3. In FIG. 4, the vertical axis represents the self-ignition incidence, and the horizontal axis represents the ignition timing. FIG. 4 is shows the self-ignition incidence when ignition is stopped in an internal combustion engine that is operating under a predetermined condition. FIG. 5 shows the surface temperature of the insulator 3 when self-ignition occurs at the self-ignition incidence at a predetermined ignition timing t shown in FIG. 4. FIGS. 4 and 5 also simultaneously show the self-ignition incidence and the surface temperature of the insulator with the spark plug 1A′ for comparison.

As shown in FIG. 4, the self-ignition incidence increases the more the ignition timing is advanced. However, with the spark plug 1A, scavenging of the plug pocket P is able to be increased by providing the tapered portion T1. Therefore, the spark plug 1A is able to reduce the self-ignition incidence more than the spark plug 1A′ even if the ignition timing is advanced. As shown in FIG. 5, the spark plug 1A is also able to reduce the surface temperature of the insulator 3 more than the spark plug 1A′, by inhibiting the occurrence of pre-ignition. As a result, an increase in temperature of the air-fuel mixture remaining in the plug pocket P due to the air-fuel mixture absorbing heat from the insulator 3 is itself also able to be inhibited.

The spark plug 1A has a structure in which the ground electrode 5 is provided on the other portion, so scavenging of the plug pocket P particularly when air-fuel mixture tends to remain in the plug pocket P is able to be preferably increased according to the position of the ground electrode 5 in the combustion chamber C. Also, with this kind of structure, machining is also able to be simplified by providing the tapered portion T1.

The spark plug 1A is able to be configured such that the width W1 is set to a size equal to or greater than the outer diameter of the insulator 3 at a predetermined position in the axial direction. Accordingly, when the airflow is made to flow into the plug pocket P via the tapered portion T1, the airflow can be made to flow in with a spread of equal to or greater than the outer diameter of the insulator 3 at the predetermined position in the axial direction. As a result, the air-fuel mixture that remains around the insulator 3 and tends to cause pre-ignition as a result of absorbing heat from the insulator 3 is able to be efficiently scavenged.

The spark plug 1A may be configured with the tapered portion T1 provided such that the length of the outer peripheral portion R11 in the circumferential direction is longer than the length of the inner peripheral portion R12 in the circumferential direction. As a result, scavenging of the plug pocket P is able to be further increased by increasing the flow rate of the airflow that flows into the plug pocket P from the tapered portion T1.

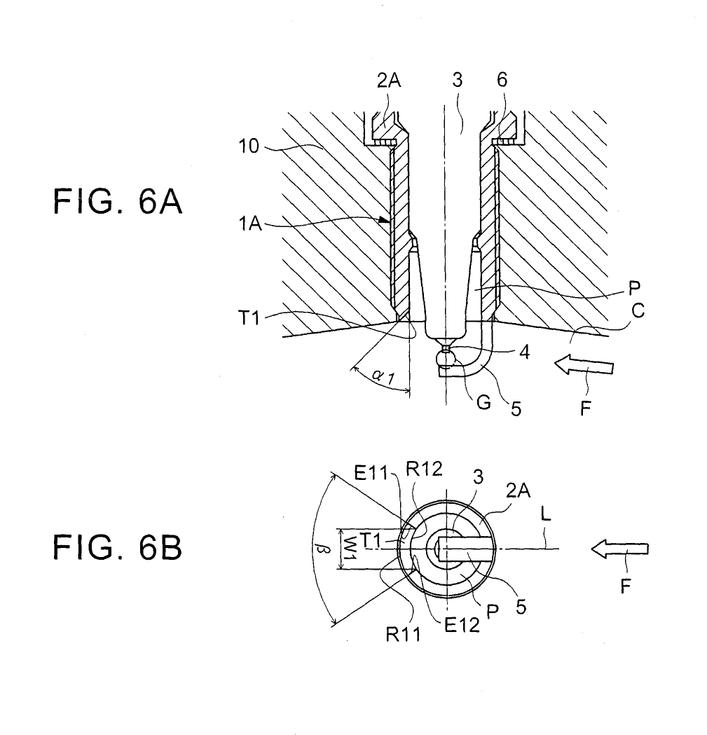

FIGS. 6A and 6B are views illustrating another arrangement example of the ground electrode 5. As shown in FIGS. 6A and 6B, the ground electrode 5 may also be arranged such that the discharge end portion is positioned downstream in the direction of the airflow F when viewed in the axial direction from the tip end side, when the spark plug 1A is provided in the cylinder head 10. Also, in this case, the ground electrode 5 impedes the inflow of the airflow that tries to flow into the plug pocket P. Also, because the inflow of this airflow into the plug pocket P is impeded, airflow also does not readily flow out of the plug pocket P. As a result, air-fuel mixture tends to remain in the plug pocket P, so pre-ignition tends to occur from the air-fuel mixture that remains in the plug pocket P.

In contrast, with the spark plug 1A, even if the ground electrode 5 is arranged in this way, providing the tapered portion T1 makes it possible to gradually change the direction of the airflow that flows out of the plug pocket P more so than when the tapered portion T1 is not particularly provided. As a result, airflow is able to more easily flow out of the plug pocket P. Also, airflow is also able to more easily flow out of the plug pocket P, by the amount of increase, due to the tapered portion T1, in a negative pressure space created on the downstream side of the insulator 3 in the direction of the airflow F, when viewed in the axial direction from the tip end side.

Therefore, in this case as well, the spark plug 1A is able to improve the temperature state of the plug pocket P by increasing the scavenging of the plug pocket P. As a result, the occurrence of pre-ignition caused by air-fuel mixture remaining in the plug pocket P is able to be inhibited.

In this case as well, the spark plug 1A is configured with the width W1 set to a size of equal to or greater than the outer diameter of the insulator 3 at a predetermined position in the axial direction, so air-fuel mixture that remains around the insulator 3 is able to be efficiently scavenged. Moreover, by setting the tapered portion T1 such that the length of the outer peripheral portion R11 in the circumferential direction is longer than the length of the inner peripheral portion R12 in the circumferential direction, the scavenging of the plug pocket P is able to be further increased.

When the spark plug 1A is provided in the internal combustion engine such that the housing portion 2A protrudes into the combustion chamber C, a through-hole may also be provided in a portion of the housing portion 2A that surrounds the plug pocket P in order to increase scavenging of the plug pocket P. However, when the spark plug 1A is provided in the internal combustion engine such that the housing portion 2A does not protrude into the combustion chamber C, scavenging of the plug pocket P is unable to be increased by providing a through-hole in the portion surrounding the plug pocket P. Therefore, the spark plug 1A is suitable for increasing scavenging of the plug pocket P when the spark plug 1A is provided in the internal combustion engine such that the housing portion 2A does not protrude into the combustion chamber C.

The spark plug 1A is able to improve scavenging of the plug pocket P using the fast flow rate of the airflow F, when the spark plug 1A is provided in an internal combustion engine in which the airflow F that flows through the discharge gap G is created, and this airflow F is made into a rotating airflow (e.g., a tumble flow or a swirl flow). Therefore, the spark plug 1A is suited to just such a structure.

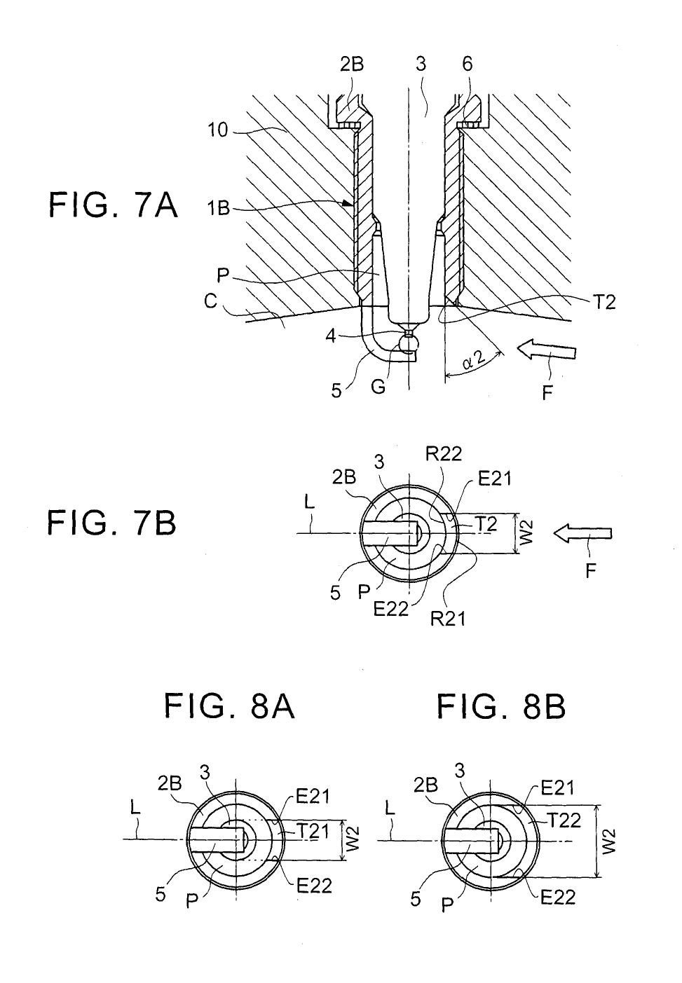

FIG. 7 is a view of the main portions of a spark plug 1B according to a second example embodiment of the invention. FIG. 7A is a sectional view of the spark plug 1B, and FIG. 7B is a bottom view of the spark plug 1B. FIGS. 7A and 7B show the main portions of the spark plug 1B in a state provided in a cylinder head 10 of an internal combustion engine. The spark plug 1B is substantially the same as the spark plug 1A except that a housing portion 2B is provided instead of the housing portion 2A.

The housing portion 2B is substantially the same as the housing portion 2A except that a tapered portion T2 is provided instead of the tapered portion T1. The tapered portion T2 is substantially the same as the tapered portion T1 except that end portions E21 and E22 are provided instead of the end portions E11 and E12, and consequently, an outer peripheral portion R21 and an inner peripheral portion R22 are provided instead of the outer peripheral portion R11 and an inner peripheral portion R12, and a width W2 is formed instead of the width W1, and further, the tapered portion T2 has a taper angle α2 instead of the taper angle α1 and the notch angle β.

The end portions E21 and E22 are provided extending along the center line L when viewed in the axial direction from the tip end side. The end portions E21 and E22 form a width W2. The width W2 is a width of a space formed by portions of the end portions E21 and E22, which are adjacent to the plug pocket P. Also, the width W2 is formed in a direction orthogonal to the center line L when viewed in the axial direction from the tip end side, similar to the width W1.

Meanwhile, with the spark plug 1B, the width formed by the portions of the end portions E21 and E22 other than the portions that are adjacent to the plug pocket P is set to the same width as the width W2. Therefore, with the spark plug 1B, the tapered portion T2 is provided such that the lengths of the outer peripheral portion R21 and the inner peripheral portion R22 in the circumferential direction are the same.

The tapered portion T2 is provided having a taper angle α2. This taper angle α2 is an acute angle formed by a central axis of the spark plug 1B or a straight line parallel thereto and a tapered surface of the tapered portion T2, at both a cross-section of the tapered portion T2 that includes the central axis of the spark plug 1B and the center line L, and a cross-section of the tapered portion T2 that is parallel thereto. The taper angle α2 is set at 45°. The taper angle α2 may be set equal to or greater than 30°, similar to the taper angle α1.

With the spark plug 1B structured in this way, the tapered portion T2 is provided on the inside of one of two portions of the tip end portion of the housing portion 2B that face one another in the radial direction, and the ground electrode 5 is provided on the other portion, similar to the spark plug 1A. Also, the width W2 is set to a size equal to or greater than the outer diameter of the insulator 3 at a predetermined position in the axial direction. The predetermined position is the same as it is with the spark plug 1A. When providing the tapered portion T2 on the one portion, the tapered portion T2 may be provided similar to the tapered portion T1.

FIGS. 8A and 8B are views of possible arrangement areas of the tapered portion T2 in the circumferential direction. FIG. 8A is a view of a tapered portion T21 that serves as the tapered portion T2 that is provided as small as possible along the circumferential direction. FIG. 8B is a view of a tapered portion T22 that serves as the tapered portion T2 that is provided as large as possible along the circumferential direction. With the tapered portion T21, the width W2 is set to match the size of the outer diameter of the insulator 3 at the position where the width W2 is formed in the axial direction, as shown in FIG. 8A. With the tapered portion T22, the width W2 is set to match the diameter of the portion of the housing portion 2B that is adjacent to the plug pocket P, as shown in FIG. 8B. With the tapered portion T22, the end portions E21 and E22 are provided so as to extend along the center line L when viewed in the axial direction from the tip end side.

Next, the main operation and effects of the spark plug 1B will be described. The spark plug 1B is able to increase the scavenging of the plug pocket P, similar to the spark plug 1A, by providing the tapered portion T2. Therefore, the occurrence of pre-ignition caused by air-fuel mixture remaining in the plug pocket P is able to be inhibited by improving the temperature state of the plug pocket P. Similar to the spark plug 1A, the spark plug 1B is able to inhibit the occurrence of pre-ignition not only when the ground electrode 5 is arranged as shown in FIGS. 7A and 7B, but also when it is arranged as shown in FIGS. 6A and 6B, in a state provided in the cylinder head 10.

The spark plug 1B is also able to efficiently scavenge air-fuel mixture remaining around the insulator 3 by the width W2 being set to a size equal to or greater than the outer diameter of the insulator 3 at a predetermined position in the axial direction, similar to the spark plug 1A. Also, similar to the spark plug 1A, the spark plug 1B is suitable for cases in which the housing portion 2B is provided in an internal combustion engine so as not to protrude into the combustion chamber C, and cases in which the housing portion 2B is provided in an internal combustion engine in which the airflow F that passes through the discharge gap G is created in the combustion chamber C, and this airflow F is made into a rotating airflow.

While the invention has been described with reference to specific embodiments thereof, the invention is not limited to these specific example embodiments. That is, various modifications and variations within the scope of the claims for patent are also possible.

For example, the tapered portion does not necessarily have to be provided such that the center line thereof overlaps with the center line of the ground electrode when viewed in the axial direction form the tip end side. Also, the tapered portion does not necessarily have to have a symmetrical shape and sandwich the center line of the ground electrode when viewed in the axial direction from the tip end side. In this case as well, the spark plug may inhibit the occurrence of pre-ignition caused by air-fuel mixture remaining in the plug pocket, by having the tapered portion be provided so as to include a center line of the ground electrode when viewed in the axial direction from the tip end side.

1. A spark plug comprising:
a housing portion;
an insulator that is retained in the housing portion;
a center electrode that is exposed from the insulator; and
a ground electrode that forms a discharge gap between the ground electrode and the center electrode, a plug pocket being formed between the housing portion and the insulator,
wherein a tapered portion is provided on an inside of a first portion of two portions of a tip end portion of the housing portion that face each other in a radial direction of the housing portion, and the ground electrode is provided on a second portion, and the tapered portion is provided only on the first portion opposite to the second portion on which the ground electrode is provided.

2. The spark plug according to claim 1, wherein a width of a space formed by portions of end portions of the tapered portion in a circumferential direction, which are adjacent to the plug pocket, is of a size that is equal to or greater than an outer diameter of the insulator at a predetermined position in an axial direction of the spark plug.

3. The spark plug according to claim 1, wherein a length, in a circumferential direction, of an outer peripheral portion of the tapered portion, which is positioned on a radially outer side of the tapered portion, is longer than a length, in the circumferential direction, of an inner peripheral portion of the tapered portion, which is positioned on a radially inner side of the tapered portion.

4. An internal combustion engine, comprising:
a cylinder head;
a combustion chamber formed by the cylinder head; and
the spark plug according to claim 1, which is fastened to the cylinder head, the spark plug being provided such that the housing portion does not protrude into the combustion chamber.

5. A spark plug comprising:
an insulator;
a center electrode that is exposed from the insulator; and
a housing portion that retains the insulator, has a plug pocket between the housing portion and the insulator, and is provided with a ground electrode that forms a discharge gap between the ground electrode and the center electrode, and in which a tapered portion is provided on an inside of a first portion of two portions of a tip end portion that face each other in a radial direction of the housing portion, and the ground electrode is provided on a second portion,
wherein the tapered portion is provided only on the first portion opposite to the second portion on which the ground electrode is provided.
